(19) United States
(12) Patent Application Publication
(10) Pub. No.: US 2024/0328942 A1
(43) Pub. Date: Oct. 3, 2024

(54) SOLID CALIBRATION STANDARDS FOR TURBIDITY MEASURING DEVICES

(71) Applicant: ABB Schweiz AG, Baden (CH)

(72) Inventors: Sylvio R. Laplante, Québec (CA); Martin C. Larouche, St-Apollinaire (CA); Eric Carbonneau, Quebec City (CA)

(21) Appl. No.: 18/194,919

(22) Filed: Apr. 3, 2023

(51) Int. Cl. G01N 21/47; G01N 21/53

(52) U.S. Cl. CPC G01N 21/4785; G01N 21/53; G01N 2201/127; G01N 2201/12715

(57) ABSTRACT

A calibration device for a turbidimeter is disclosed. The calibration device includes a body made from a light-permeable material having a first end and a second end defining a length. The calibration device further includes at least one calibration portion defined by a first aperture having a light scattering pattern. The first aperture is oriented perpendicular to the first end, and the first aperture extends into the body a first distance that is less than the length of the body. The turbidimeter is calibrated by inserting one of the at least one calibration portion of the calibration device into the sensing region.

### BACKGROUND

The field of the disclosure relates generally to turbidimeters, and more particularity, to calibration devices for turbidimeters.

Turbidity is defined as the cloudiness of a liquid due to the presence of suspended matter in the liquid. Turbidity in liquids is caused by small suspended (undissolved) particles having a different refractive index than the surrounding medium, such as drinking water for example. The turbidity of liquid, such as drinking water defines the clarity/transparency/cloudiness of the liquid. Water with a low turbidity value is associated with drinkable water while water with a high turbidity value is associated with water that is opaque and not safe to drink.

Turbidity is a primary factor used to assess the quality of drinking water. Bacteria, viruses, and parasites can attach themselves to the suspended particles in turbid water. These particles then interfere with water disinfection by shielding contaminants from the disinfectant (e.g. chlorine). As a result, the turbidity of drinkable water is regularly monitored to confirm that it is safe to consume.

In drinking water monitoring, the turbidity of drinkable water is determined by devices called turbidimeters. Some turbidimeters operate continuously which allows the water flow to circulate through a flow cell where the turbidity of the water is measured. The determination of the water turbidity is often carried out using nephelometric techniques. Nephelometry corresponds to the measurement of scattered light at a 90-degree angle relative to the to the direction of the incident light. In continuous flow devices, a light source, such as a light emitting diode (LED), emits a ray of light that is directly incident upon a flow cell in which flows water. A photodetector, located at a right angle from the incident light, generates a signal proportional to the intensity of the light that is scattered at a right angle relative to the incident light. The signal measured by the detector therefore varies with the water turbidity.

However, known turbidimeters need to be calibrated on a regular basis in order to accurately associate a water turbidity value to the signal generated by the photodetector. Such calibration has been completed using formazine suspensions. For instance, recognized calibration methods ISO7027 as well as EPA 180.1 both require the use of formazine suspensions. The formazine suspensions are prepared by mixing hydrazine sulfate and hexamethylenetetramine with ultrapure water. The concentrations of the formazine must meet specific quality control specifications to guarantee their accuracy assessing water turbidity. Because the formazine needs to be prepared consistent with the required concentration guidelines, turbidimeter calibration using the formazine can be complicated. Therefore there is a need to develop an alternative simpler method for performing calibration and calibration verification on turbidity measuring devices which does not require the use of liquid calibration standards i.e. formazine suspensions.

### BRIEF DESCRIPTION

In one aspect of the present disclosure, a calibration device for a turbidimeter is disclosed. The calibration device includes a body having a first end and a second end defining a length. The body is made from a light-permeable material. The calibration device further includes at least one calibration portion defined by a first aperture having a light scattering pattern. The first aperture is oriented perpendicular to the first end, and the first aperture extends into the body a first distance that is less than the length of the body. The turbidimeter is calibrated by inserting one of the at least one calibration portion of the calibration device into a sensing region of the turbidimeter.

In another aspect of the present disclosure, a turbidimeter is disclosed. The turbidimeter includes a light source configured to emit light through the liquid flow cell defining a light transmission path and a photodetector configured to receive at least one of refracted, diffused and reflected light through the liquid flow cell. The photodetector is oriented perpendicular to the light source. The light source and the photodetector defining a measurement plane perpendicular to the flow axis. Light from the light source at least one of refracts, diffuses and reflects within the liquid flow cell, and the turbidity is determined by at least one of refracted, diffused and reflected light received by the photodetector. The turbidimeter is calibrated by inserting one of the at least one calibration portion of the calibration device into the light transmission path and by emitting light from the light source along the light transmission path and through the calibration portion of the calibration device.

### BRIEF DESCRIPTION OF THE DRAWINGS

FIG. 1 illustrates a perspective view of a solid calibration standard in accordance with embodiments of the present disclosure;

FIG. 2 illustrates a schematic top view of the solid calibration standard of FIG. 1;

FIG. 3 illustrates a schematic cross-sectional view of the solid calibration standard of FIG. 2 taken along cross-section line B-B′;

FIG. 4 illustrates a schematic representation of a turbidity measuring system in accordance with embodiments of the present disclosure;

FIGS. 5A and 5B illustrate schematic representations of a turbidimeter along a light transmission path in accordance with embodiments of the present disclosure;

FIG. 6 illustrates a schematic representation of a transverse view of the turbidimeter of FIGS. 5A and 5B;

FIG. 7 illustrates a schematic cross-sectional view of the solid calibration standard of FIG. 2 taken along cross-section line B-B′;

FIGS. 8 and 9 illustrate schematic top views of the solid calibration standard of FIG. 1;

FIGS. 10 and 11 illustrate schematic cross-sectional views of the solid calibration standard of FIG. 2 taken along cross-section line B-B′;

FIG. 12A illustrates a schematic representation of a transverse view of the turbidimeter of FIGS. 5A and 5B in a first calibration state;

FIG. 12B illustrates a schematic representation of a transverse view of the turbidimeter of FIGS. 5A and 5B in a second calibration state; and,

FIG. 12C illustrates a schematic representation of a transverse view of the turbidimeter of FIGS. 5A and 5B in a third calibration state.

The reference symbols used in the drawings, and their meanings, are listed in summary form in the list of reference symbols. In principle, identical parts are provided with the same reference symbols in the figures.

### DETAILED DESCRIPTION

In the following specification and the claims, reference will be made to a number of terms, which shall be defined to have the following meanings.

As used herein, the singular forms “a,” “an,” and “the” include plural references unless the context clearly dictates otherwise. The terms “comprising,” “including,” and “having” are intended to be inclusive and mean that there may be additional elements other than the listed elements. The terms “optional” or “optionally” means that the subsequently described event or circumstance may or may not occur, and that the description includes instances where the event occurs and instances where it does not.

Embodiments of the present disclosure are directed to a calibration device for a turbidimeter, the turbidimeter having a sensing region. The calibration device includes a body having a first end and a second end defining a length. The body is made from a light-permeable material. The calibration device further includes at least one calibration portion defined by a first aperture having a light scattering pattern. The first aperture is oriented perpendicular to the first end, and the first aperture extends into the body a first distance that is less than the length of the body. The turbidimeter is calibrated by inserting one of the at least one calibration portion of the calibration device into the sensing region.

In particular, the turbidimeter includes a light source configured to emit light through the liquid flow cell defining a light transmission path and a photodetector configured to receive at least one of refracted, diffused and reflected light through the liquid flow cell. The photodetector is oriented perpendicular to the light source. The light source and the photodetector defining a measurement plane perpendicular to the flow axis. Light from the light source at least one of refracts, diffuses and reflects within the liquid flow cell, and the turbidity of a sample flowing through the flow channel is determined by at least one of refracted, diffused and reflected light received by the photodetector. The turbidimeter is calibrated by inserting one of the at least one calibration portion of the calibration device into the light transmission path and by emitting light from the light source along the light transmission path and through the calibration portion of the calibration device.

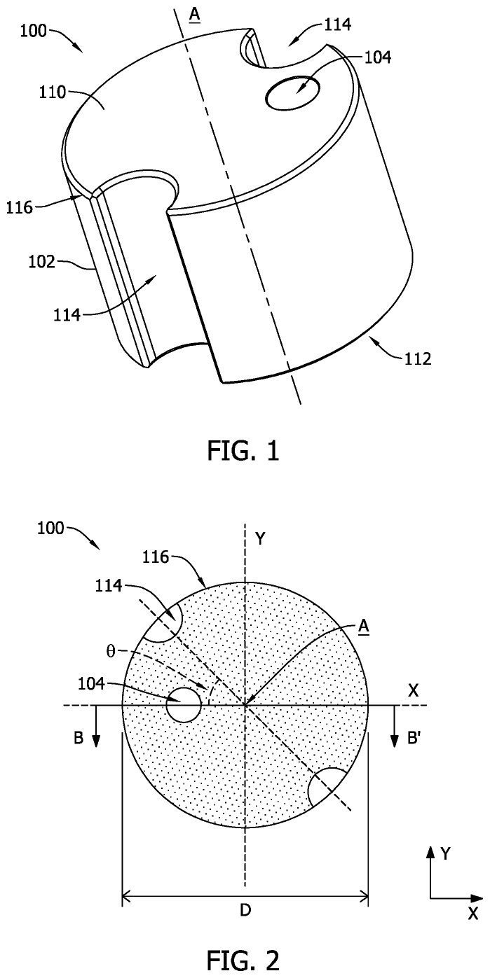

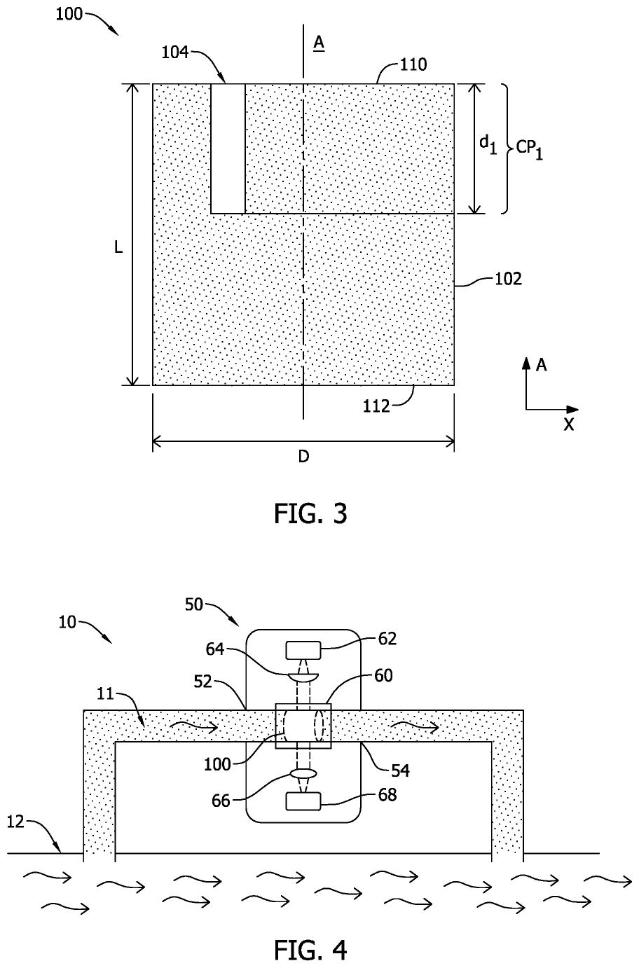

FIG. 1 illustrates a perspective view of a solid calibration device 100 (also referred to as a “calibration standard”) in accordance with embodiments of the present disclosure. FIG. 2 illustrates a schematic top view of the solid calibration standard of FIG. 1, and FIG. 3 illustrates a schematic cross-sectional view of the solid calibration standard of FIG. 2 taken along cross-section line B-B′ of FIG. 2. The calibration device 100 can be utilized for calibrating a turbidimeter 50 represented schematically in FIG. 4 and (or more generally a turbidity measuring device) as explained in further detail below.

Referring to FIGS. 1 through 3, the calibration device 100 includes a body 102 having a first end 110 and a second end 112 and a length L between the ends 110, 112 of the body 102 of the calibration device 100 generally. The calibration device 100 is made from a light-permeable material having a known scattering pattern. In some embodiments, the body 102 is made from two or more light-permeable materials having known and different scattering patterns. The scattering pattern of each light-permeable material produces a desired turbidity level, or more generally, a known and different reading from a turbidimeter. In some embodiments, the multiple light-permeable materials are stacked and/or laminated together to form the body 102.

As used herein, the term “light” refers to incident light, which may be in the infrared, visible light and/or ultraviolet spectrums. As used herein, the term “scattering pattern” and “light scattering pattern” shall denote a known level of signal generated on a photodetector by one or more of refraction, diffusion, reflection and transmission. The scattering pattern is determined by optical properties of materials or surfaces.

As used herein, the term “known” when referring to a known scattering pattern denotes an empirically determined scattering pattern. As used herein, the term “negligible” when referring to a negligible scattering pattern denotes a scattering pattern that is not detectable by a turbidimeter and produces a zero measurement by the turbidimeter. It is understood that turbidimeters may have varying sensitivities, and therefore a negligible scattering pattern for a turbidimeter having a greater sensitivity may produce a measurement other than a zero measurement. The sensitivity of the turbidimeter is application dependent. As such, a calibration device having a “known and negligible scattering pattern” denotes a calibration device that produces a zero or near-zero measurement from a turbidimeter, and the zero or near-zero measurement is known by previous empirical determinations.

In the illustrated embodiments, the body 102 has a cylindrical configuration having a length L (as best shown in FIG. 3) defined between the first end 110 and the second end 112 and a diameter D (as best shown in FIGS. 2 and 3). Although in the illustrated embodiment, the body 102 has a cylindrical configuration, it is understood that the body 102 may have any configuration. By way of example, but not limitation, the body 102 in some embodiments has a configuration selected from the group consisting of a rectangle, a triangle, a trapezoid and an oval.

The body 102 has a central axis A that extends beyond the ends 110, 112 of the body 102 and is perpendicular to the body ends. As best shown in FIG. 2, a light transmission plane (defined by X-axis and Y-axis) is parallel to the first end 110 of the body 102. The light transmission plane is therefore perpendicular to the central axis A of the body 102. The central axis A along with X-axis and Y-axis of the light transmission plane define a three-dimensional orientation.

The calibration device 100 further includes a first aperture 104 extending from the first end 110 oriented perpendicular to the first end 110 (and perpendicular to the light transmission plane). The first aperture 104 extends a first distance d₁ from the first end 110 partially into the length L of the body 102, and the first aperture 104 is laterally offset from the central axis A. The first aperture 104 is oriented along the X-axis. In the illustrated embodiment, the first distance d₁ is less than the length L of the body 102. In some embodiments, the first aperture 104 is concentric with the central axis A. As shown in FIG. 11, in some embodiments, the first aperture 104 extends from the first end 110 to the second end 112.

The first distance d₁ defines a first calibration portion CP₁ of the calibration device 100. As explained in greater detail below, the first aperture 104 has a known and non-negligible scattering pattern such that placement of the calibration device 100 (and more specifically the first calibration portion CP₁) within a sensing region of a turbidimeter produces a non-zero and known turbidity measurement from the turbidimeter. Therefore, the light scattering pattern of the first aperture 104 defines a light scattering pattern of the first calibration portion CP₁ of the calibration device 100. In some embodiments, the first calibration portion CP₁ of the calibration device 100 includes multiple apertures 104, which in some embodiments have different light scattering patterns. Therefore, the light scattering pattern(s) of one or more apertures within a calibration portion define a light scattering pattern of the calibration portion. As shown in FIGS. 1, 2 and 5B, in some embodiments, the body 102 further includes at least one flow notch 114 extending from the first end 110 to the second end 112 of the body 102. Each notch 114 includes a notch opening provided along the outer peripheral surface 116 of the body 112. Each notch enables fluid, such as water to flow through the notches and around the body 102 when the calibration device 100 is positioned within a turbidimeter.

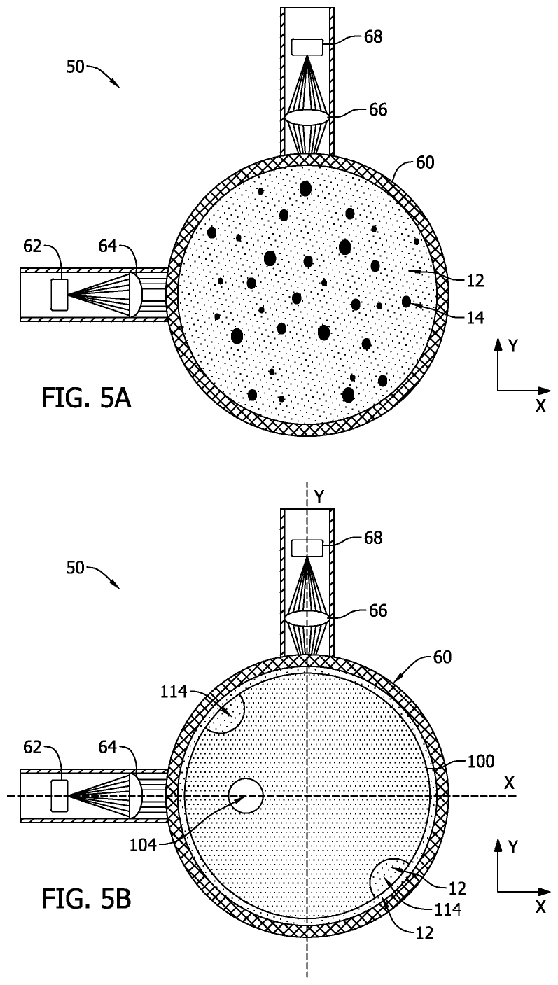

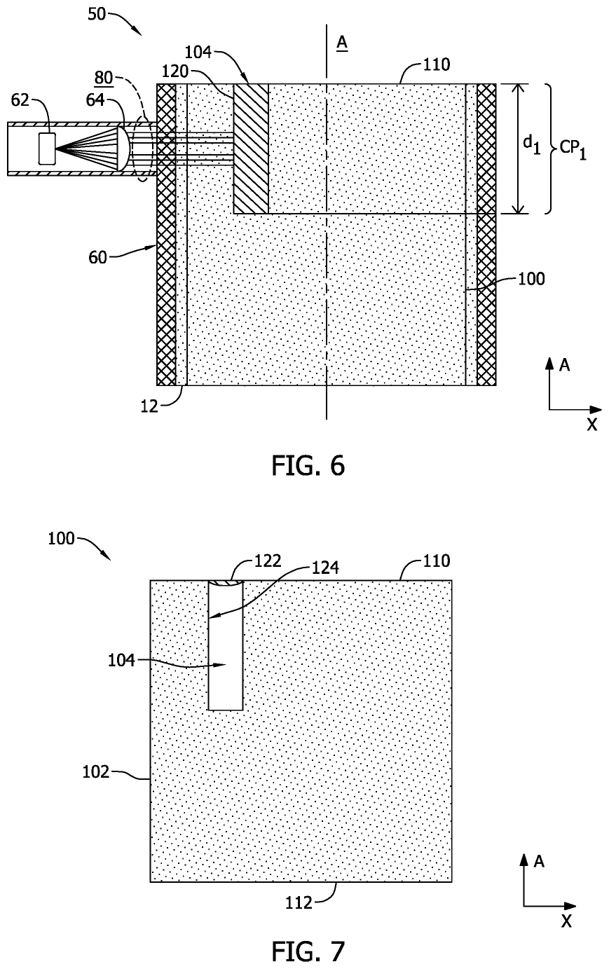

FIG. 4 is a schematic representation of a turbidity measuring system 10 including a turbidimeter 50 in accordance with embodiments of the present disclosure. FIGS. 5A and 5B illustrate schematic representations of the turbidimeter 50 including transversely directed light transmission paths in accordance with embodiments of the present disclosure. FIG. 6 illustrates a schematic representation of a transverse view of the turbidimeter of FIGS. 5A and 5B;

Referring to FIG. 4, the system 10 taps into a fluid conduit 11 such that a sample 12 of fluid flows through an inlet 52 of the turbidimeter 50. As the sample 12 of fluid flows through the turbidimeter 50, the turbidity of the sample 12 is analyzed through a liquid flow cell 60 of the turbidimeter 50 and subsequently flows out from an outlet 54 of the turbidimeter 50. In the illustrated embodiment, the sample 12 returns to the fluid conduit 11, however in alternative embodiments the sample 12 is diverted from the outlet 54 to waste.

Referring to FIGS. 4 and 5A-5B and 6, the liquid flow cell 60 of the turbidimeter 50 includes a light source 62 (such as a diode) oriented upstream of a source collimating lens 64. Light from the light source 62 is directed downstream to the source collimating lens 64 which emits light that is directed toward and into the liquid flow cell 60. As light from the collimating lens 64 enters the liquid flow cell 60, suspended matter 14 (such as contaminants) scatter the light and the scattered light is then emitted from the liquid flow cell 60 toward a condenser lens 66 which receives the emitted scattered light. A photodetector 68 is oriented upstream from the condenser lens 66 in the direction of emission of the light. The photodetector 68 captures light from the condenser lens 66 to produce a turbidity measurement on the turbidimeter 50 based on the light scattered due to the presence of suspended matter 14 in the sample 12. The turbidity measurement is a numerical representation of the light scattered due to the presence of suspended matter 14 within the sample 12. In some embodiments, the measurement is represented as a spectrum indicating various elements within the suspended matter 14. The liquid flow cell 60 is thus configured to illuminate the sample 12 with incident light which then scatters in all directions within the liquid flow cell 60. The photodetector 68 then captures scattered light from the condenser lens 66 to produce a turbidity measurement on the turbidimeter 50.

The liquid flow cell 60 has a tubular-shaped sidewall made from a light-permeable material. The light source 62 is configured to emit light through the liquid flow cell 60 defining a light transmission path (parallel to the light transmission plane), and the photodetector 68 configured to receive at least one of refracted, diffused and reflected light as explained in further detail below. Light from the light source 62 at least one of refracts, diffuses and reflects within the liquid flow cell 60, and the turbidity of the sample 12 flowing through the liquid flow cell 60 is determined by at least one of refracted, diffused and reflected light received by the photodetector 68.

As best shown in FIG. 6, the calibration device 100 is positioned within the liquid flow cell 60 such that the first aperture 104 and the calibration portion CP₁ is within the light transmission path 80 of the light source 62 and the collimating lens 64. Referring to FIG. 5B, the calibration device 100, and the first aperture 104 specifically—are oriented within the liquid flow cell 60 such that the X-axis of the body 102 is axially aligned with the light source 62 and the collimating lens 64. In some embodiments, the first aperture 104 is concentric with the central axis A. In some embodiments, the first aperture 104 is positioned at any location on the first end 110 of the body 102 to generate a desired turbidity measurement. The condenser lens 66 and the photodetector 68 are perpendicular to the light source 62 and the collimating lens 64 and are located in the light transmission plane (defined by X-axis and Y-axis). The condenser lens 66 and photodetector 68 are located along the Y-axis of the body as shown in FIG. 5B.

Turning to FIG. 6, the light from the collimating lens 64 refracts by passing through the first aperture 104 and the photodetector 68 detects the refracted light to produce the turbidity measurement on the turbidimeter 50. The light refracts within the light transmission path 80 such that the refracted light remains substantially parallel to the light transmission path 80. As shown in FIG. 5B, with the body 102 positioned within the liquid flow cell 60, fluid flows restrictively around the body 102, but freely through the at least one flow notch 114. The flow notch 114 in the illustrated embodiments has a semicircular shape, however it is understood that the flow notch 114 may have any shape to facilitate free flow of fluid through the flow notch 114. The at least one flow notch 114 is oriented by an angle θ relative to the first aperture 104 and the X-axis in the light transmission plane (defined by X-axis and Y-axis). In some embodiments, the angle θ oriented 45 degrees relative to the first aperture 104.

As previously set forth, the light scattering pattern of the first aperture 104 defines a light scattering pattern of the first calibration portion CP₁ of the calibration device 100. As explained in further detail below, the scattering pattern of the first aperture 104 may be altered depending on one or more aspects of the aperture 104 such as the geometry of the first aperture 104, a material disposed within the first aperture 104, the position of the aperture 104 on the first end 110 of the body 102 and the like. In some embodiments, the first calibration portion CP₁ of the calibration device 100 includes multiple apertures 104, which in some embodiments have different light scattering patterns. Therefore, the light scattering pattern(s) of one or more apertures within a calibration portion define a light scattering pattern of the calibration portion. In some embodiments, the body 102 defined by the first calibration portion CP₁ is made from a different light-permeable material relative to the whole body 102. The different light-permeable material of the first calibration portion CP₁ has a different scattering pattern relative to the whole body 102. The scattering pattern of the first calibration portion CP₁ may thus be defined by the light-permeable material of the first calibration portion CP₁ and the light scattering pattern(s) of the one or more apertures 104.

As shown in FIG. 6, in some embodiments, a light-permeable material 120 is disposed within the aperture 104, and the light-permeable material 120 has a known and non-negligible light scattering pattern, which defines the light scattering pattern of the first calibration portion CP₁.

As shown in FIG. 7, in some embodiments, the body 102 further comprises a seal 122 at the first end 110 of the body 102 to fluidly close the first aperture 104. In some embodiments, a light-permeable material (not shown) having a known and non-negligible light scattering pattern is enclosed within the first aperture 104. The light scattering pattern of the light-permeable material (not shown) defines the light scattering pattern of the first calibration portion CP₁.

In some embodiments, a vacuum is applied within the first aperture 104 and the seal 122 is configured to maintain the vacuum. As shown in FIG. 7, in some embodiments, the first aperture 104 defines an inner surface 124 having a surface finish, the surface finish defines the light scattering pattern of the first calibration portion CP₁.

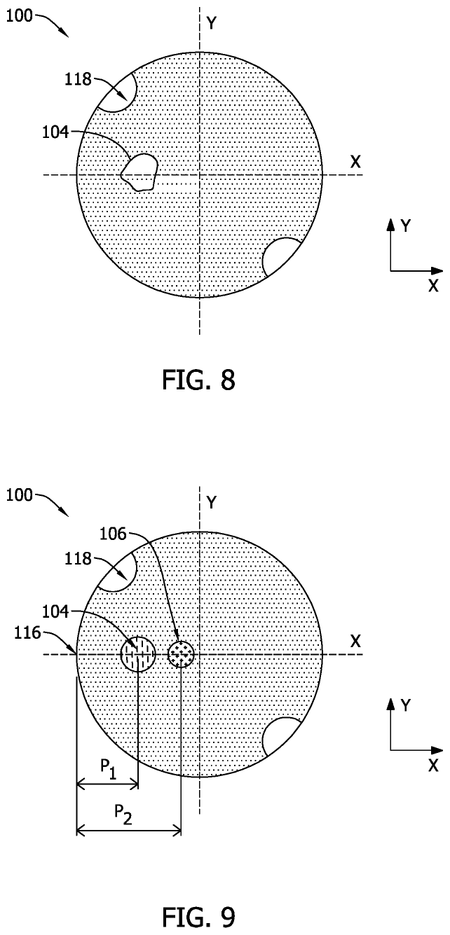

As shown in FIG. 8, in some embodiments, the first aperture 104 has a shape selected from the group consisting of: a circle, a rectangle, a triangle, a trapezoid and an oval. More generally, the first aperture 104 can have any shape. In embodiments where the first aperture 104 has a circular shape, the diameter of the circular shape defines the light scattering pattern of the first calibration portion CP₁. More generally, the shape and size of the first aperture 104 defines the light scattering pattern of the first calibration portion CP₁.

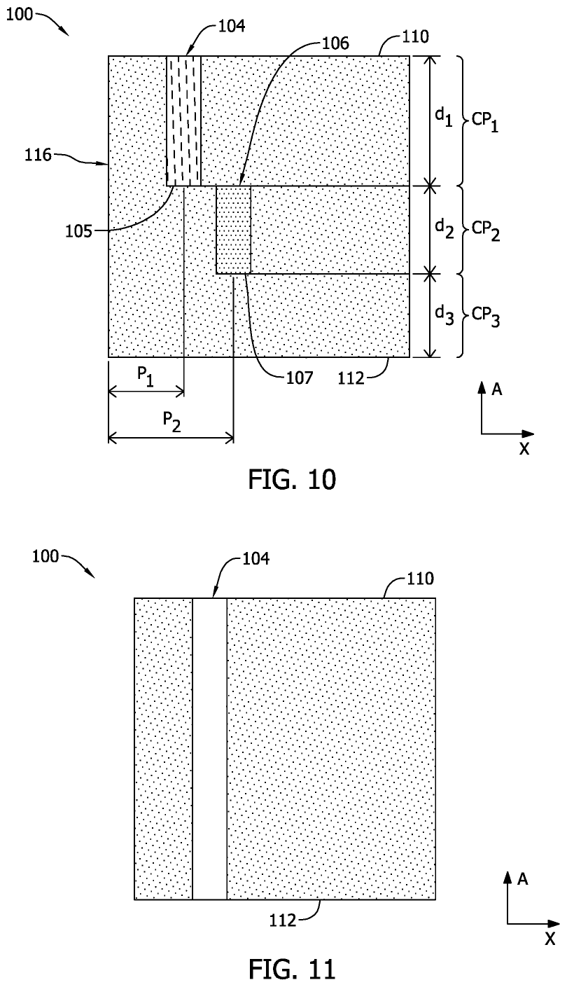

As shown in FIGS. 9 and 10, the first aperture 104 is positioned a distance P₁ from the outer peripheral edge 116. The distance P₁ defines the light scattering pattern of the first calibration portion CP₁. In the illustrated embodiments, the first aperture 104 is positioned along the X-axis, however it is understood that the first aperture 104 may be positioned at any location on the first end 110, including at the central axis A. The position of the first aperture 104 thus defines the light scattering pattern of the first calibration portion CP₁.

As shown in FIGS. 9 and 10, in some embodiments, the calibration device 100 further comprises a second aperture 106 defining a second calibration portion CP₂. The light scattering pattern of the second aperture 106 defines a light scattering pattern of the second calibration portion CP₂ of the calibration device 100. Similar to the first aperture 104, the second aperture 106 has a known and non-negligible light scattering pattern which is different than the light scattering pattern of the first aperture 104. In some embodiments, the second aperture 106 is coplanar with the first aperture 104. In some embodiments, the second aperture 106 extends from an end 105 of the first aperture 104 into the body 102 by a second distance d₂ that is less than the length L of the body 102.

Similar to the first calibration portion CP₁, in some embodiments, the second calibration portion CP₂ of the calibration device 100 includes multiple apertures 106, which in some embodiments have different light scattering patterns. Therefore, the light scattering pattern(s) of one or more second apertures 106 within the second calibration portion CP₂ define a light scattering pattern of the second calibration portion CP₂. Also similar to the first calibration portion CP₁, the body 102 defined by the second calibration portion CP₂ is made from a different light-permeable material relative to the whole body 102 and to the first calibration portion CP₁. The different light-permeable material of the second calibration portion CP₂ has a different scattering pattern relative to the whole body 102 and to the first calibration portion CP₁. The scattering pattern of the second calibration portion CP₂ may thus be defined by the light-permeable material of the second calibration portion CP₂ and the light scattering pattern(s) of the one or more second apertures 106.

In the illustrated embodiments, the calibration device 100 has two calibration portions (CP₁, CP₂) each defined by an aperture (104, 106), however it is understood that the body 102 can have any number of calibration portions defined by an aperture, each of the calibration portions having a known and non-negligible scattering pattern defined by the aperture. The second aperture 106 is positioned a distance P₂ from the outer peripheral edge 116. In some embodiments, the distance P₁ of the first aperture 104 and the distance P₂ of the second aperture 106 are equal or unequal.

A third calibration portion CP₃ (also referred to as a blank portion) having a third distance d₃ defined between an end 107 of the second aperture 106 and the second end 112 of the body 102 does not have an aperture, and therefore the light diffusion of the third calibration portion CP₃ is determined only by the light-permeable material of the third calibration portion CP₃. In some embodiments, the third calibration portion CP₃ has the same light-permeable material as the light-permeable material of the body 102. The third calibration portion CP₃ has a known scattering pattern.

In some embodiments, the third calibration portion CP₃ is a blank portion which, when placed in the light transmission path 80, zeroes the turbidimeter 50 to produce a zero reading or produce a base value reading. In some embodiments, the calibration device 100 includes multiple blank portions made from different light-permeable materials having different scattering patterns. Each of the multiple blank portions may be configured to provide a range of upper and lower limits for calibrating the turbidimeter 50 between upper and lower limits for which the turbidimeter 50 operates in.

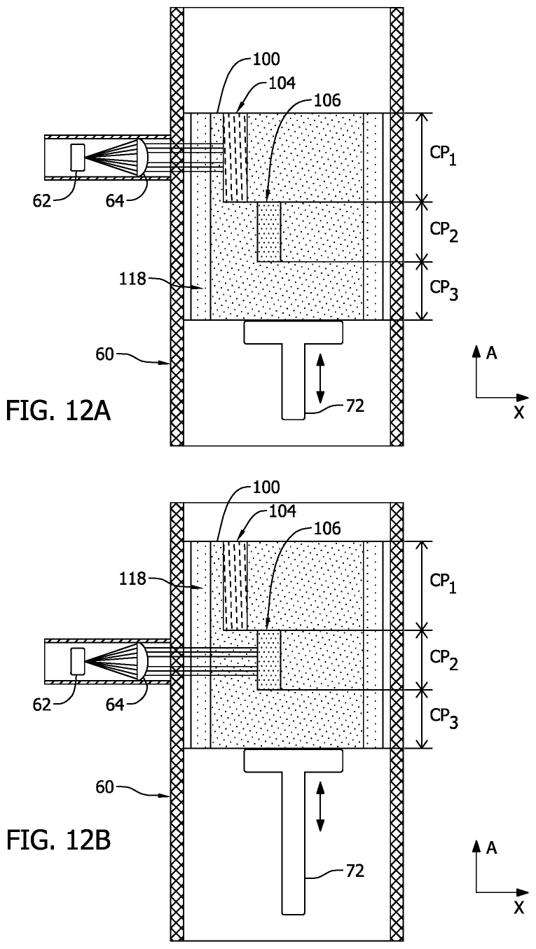

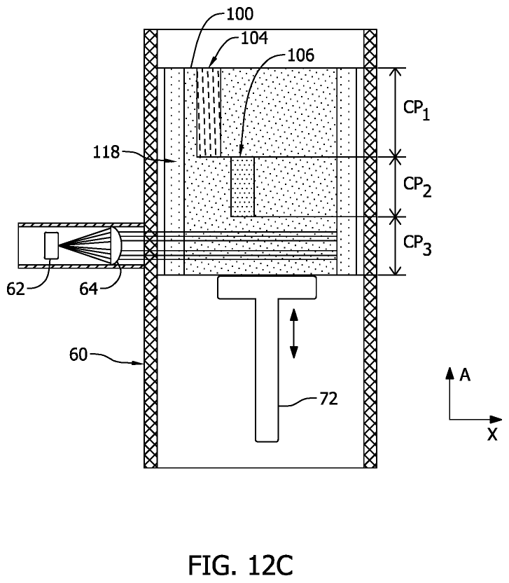

FIGS. 12A through 12C illustrate schematic representations of the in a first calibration state, a second calibration state and a third calibration state of the turbidimeter 50. As shown in FIG. 12A, in the first calibration state, the first calibration portion CP₁ is positioned within the light transmission path. In the second calibration state, the second calibration portion CP₂ is positioned within the light transmission path. In the third calibration state (also referred to as a blank or zero state), the third calibration portion CP₃ is positioned within the light transmission path.

To place the turbidimeter 50 in any of the three calibration states, the turbidimeter 50 further comprises a platform 72 abutting the second end 112 of the calibration device 100 to facilitate advancement of the calibration device 100 between one or more of the calibration states such that for each calibration state, the light source 62 emits light through one of the at least one calibration portions to calibrate the turbidimeter 50. During normal operation of the turbidimeter 50, the platform 72 pushes the entire calibration device 100 outside of the light transmission path such that the calibration device 100 may remain within the calibration device 100 without affecting reading of the sample 12 (as shown in FIG. 5A).

The described embodiments provide a calibration device 100 which, by the use of one or more apertures, enables a single calibration device to provide more than one calibration standard for a turbidimeter. By way of example, the first aperture can have a scattering pattern at a lower limit of a specific application and the second aperture can have a scattering pattern at an upper limit for the specific application, and therefore, by use of the platform, the turbidimeter can be calibrated for both lower and upper limits of the specific application.

The described embodiments also provide for multiple means for determining/adjusting the optical properties of the calibration portions. In particular, the scattering patterns of the calibration portions are determined by one or more of the shapes of the first apertures, the surface finish of the inner surface of the apertures, the material properties of a material disposed within the apertures, the distances of the apertures from the outer peripheral edge of the calibration device, and the light-permeable material of the calibration portions.

Other variations to the disclosed embodiments can be understood and effected by those skilled in the art in practicing the claimed invention, from the study of the drawings, the disclosure, and the appended claims. In the claims the word “comprising” does not exclude other elements or steps and the indefinite article “a” or “an” does not exclude a plurality. The mere fact that certain measures are recited in mutually different dependent claims does not indicate that a combination of these measures cannot be used to advantage. Any reference signs in the claims should not be construed as limiting the scope of the claims.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A calibration device for a turbidimeter having a sensing region comprising:
a body having a first end and a second end defining a length, the body comprised of a light-permeable material; and,
at least one calibration portion defined by a first aperture having a light scattering pattern, the first aperture being oriented perpendicular to the first end, the first aperture extending into the body a first distance that is less than the length of the body;
wherein the turbidimeter is calibrated by inserting one of the at least one calibration portion of the calibration device into the sensing region.

2. The calibration device of claim 1 further comprising a second calibration portion defined by a second aperture having a light scattering pattern, the second aperture extending from an end of the first aperture into the body a second distance that is less than the length of the body.

3. The calibration device of claim 1 further comprising one or more blank portions between an end of the at least one calibration portion and the second end of the body, each of the blank portions having a scattering pattern determined by a light-permeable material of the one or more blank portions.

4. The calibration device of claim 1, wherein the sensing region of the turbidimeter is defined by a light source oriented perpendicular to a photodetector on a light transmission plane, the first aperture of the at least one calibration portion oriented perpendicular to the light transmission plane.

5. The calibration device of claim 1, further comprising a light-permeable material disposed within the first aperture, the light-permeable material of the first aperture defining the light scattering pattern, the light-permeable material of the first aperture being different than the light-permeable material of the body.

6. The calibration device of claim 1, wherein the first aperture defines an inner surface having a surface finish, the surface finish defining the light scattering pattern.

7. The calibration device of claim 1, wherein the first aperture has a circular shape having a diameter, the diameter the defining the light scattering pattern.

8. The calibration device of claim 1, wherein the first aperture has a shape selected from the group consisting of: a rectangle, a triangle, a trapezoid and an oval, the shape of the first aperture defining the light scattering pattern.

9. The calibration device of claim 1, wherein the first aperture is positioned a distance from an outer peripheral edge of the first end, the distance defining the light scattering pattern.

10. The calibration device of claim 1, wherein the at least one calibration portion further comprises a second aperture oriented parallel to the first aperture, the second aperture having an optical property, wherein the optical property of the first aperture and the optical property of the second aperture define a light scattering pattern of the at least one calibration portion.

11. The calibration device of claim 1, wherein the body further comprises a seal at the first end of the body, the seal configured to close the first aperture.

12. The calibration device of claim 11, wherein a vacuum is applied within the first aperture.

13. The calibration device of claim 12, wherein the first aperture defines an inner surface, the inner surface having a surface finish, the surface finish defining the light diffusion pattern of the first aperture.

14. The calibration device of claim 1, wherein the scattering pattern of each of the at least one calibration portion is defined by a light-permeable material of the at least one calibration portion and the light scattering pattern of one or more apertures positioned within each of the at least one calibration portion.

15. The calibration device of claim 1, wherein the body has a shape selected from the group consisting of a cylinder, a rectangle, a triangle, a trapezoid and an oval.

16. The calibration device of claim 1, wherein the body further comprises at least one flow notch extending from the first end to the second end of the body.

17. The calibration device of claim 16, wherein the at least one flow notch is oriented 45 degrees relative to the first aperture.

18. A turbidimeter apparatus comprising:
a light source configured to emit light through a liquid flow cell made from a light-permeable material defining a light transmission path; and,
a photodetector configured to receive at least one of refracted, diffused and reflected light through the liquid flow cell, the photodetector oriented perpendicular to the light source, the light source and the photodetector defining a measurement plane; wherein the light from the light source at least one of refracts, diffuses and reflects within the liquid flow cell, and wherein the turbidity is determined by at least one of refracted, diffused and reflected light received by the photodetector; and,
a calibration device positionable within the liquid flow cell, the calibration device comprising:
a body having a first end and a second end defining a length, the body comprised of a light-permeable material; and,
at least one calibration portion defined by a first aperture having a light scattering pattern, the first aperture being oriented perpendicular to the first end, the first aperture extending into the body a first distance that is less than the length of the body;
wherein the turbidimeter is calibrated by inserting one of the at least one calibration portion of the calibration device into the light transmission path and by emitting light from the light source along the light transmission path and through the calibration portion of the calibration device.

19. The apparatus of claim 18, wherein the scattering pattern of each of the at least one calibration portion is defined by a light-permeable material of the at least one calibration portion and a light scattering pattern of one or more apertures positioned within each of the at least one calibration portion, wherein the light scattering pattern of the one or more apertures is determined by one or more of: a shape of the one or more apertures, a surface finish of inner surfaces of the one or more apertures, a material disposed within the one or more apertures, and positioning of the one or more apertures within the calibration device.

20. The apparatus of claim 19 further comprising a platform abutting the second end of the calibration device to facilitate advancement of the calibration device between one or more calibration states such that each calibration state the light source emits light through one of the at least one calibration portion the calibration portion of the calibration device to calibrate the turbidimeter.
